(19) United States
(12) Patent Application Publication
(10) Pub. No.: US 2011/0169185 A1
(43) Pub. Date: Jul. 14, 2011

(54) FORMING METHOD AND THREE DIMENSIONAL OBJECT

(75) Inventor: Yoichi NODA, Fujimi (JP)

(73) Assignee: SEIKO EPSON CORPORATION, Tokyo (JP)

(21) Appl. No.: 13/004,244

(22) Filed: Jan. 11, 2011

(30) Foreign Application Priority Data
Jan. 13, 2010 (JP) 2010-004648

(51) Int. Cl. B32B 38/14

(52) U.S. Cl. 264/134

(57) ABSTRACT

A forming method includes: drawing, using a thermosetting liquid which has a non-water-soluble property in at least a cured state, a sectional pattern of a three dimensional object which is a forming target on a water-soluble recording medium which has acceptability for the liquid; heating, in a state where the plurality of recording mediums on which the sectional pattern is drawn is overlapped, the plurality of recording mediums, after the drawing; and dissolving at least an area outside the sectional pattern in each of the plurality of recording mediums using a liquid which includes water, after the heating.

### BACKGROUND

1. Technical Field

The present invention relates to a forming method and a three dimensional object.

2. Related Art

In the related art, a stacking method is known as a method of forming a three dimensional object (forming method). In the stacking method, the three dimensional object is generally formed by sequentially forming and stacking a plurality of individual sectional elements which defines the appearance of the three dimensional object.

As an example of such a stacking method, there is in the related art a method which includes printing each sectional element of the three dimensional object on a sheet using a printer and sequentially stacking the printed sheets (refer to JP-A-7-285179, for example).

In the forming method disclosed in JP-A-7-285179, each sheet is decomposed along an appearance pattern of the sectional element in a stacked body in which the plurality of sheets is stacked, so that the three dimensional object is separated from the stacked body. According to JP-A-7-285179, ink used in printing is a special ink which can decompose the sheet. In JP-A-7-285179, ink which includes chemicals is disclosed as an example.

As the chemicals, sulfuric acid, hydrochloric acid, or the like are exemplified. As these chemicals are in contact with the sheet, the sheet is decomposed.

Further, JP-A-7-285179 discloses that flammable chemicals may also be employed. The flammable chemicals are activated to generate inflammation. Thus, it is possible to separate the sectional element from the sheet.

However, in view of safety in the forming method, it is preferable to prevent the above-described various chemicals from being used or the inflammation from being generated.

As a method capable of enhancing safety, for example, a method is considered in which the sectional element is printed on a water-soluble sheet using a non-water-soluble ink, to thereby form a stacked body. Then, when a three-dimensional object is formed from the stacked body, water is applied to the stacked body. Thus, the sheet is dissolved in water, thereby making it possible to obtain the three-dimensional object.

However, in this method, the water-soluble sheet and the non-water-soluble ink are alternately overlapped with each other in the stacked body, and thus, the water-soluble sheet is interposed between two sectional elements in the stacked body. If water is applied to this stacked body, the sheet between two sectional elements is dissolved. If the sheet between two sectional elements is dissolved, the two sectional elements are easily separated from each other. As a result, in the forming method using the water-soluble sheet and the non-water-soluble ink, it is difficult to form the three-dimensional object.

As described above, in the forming method in the related art, it is difficult to form the three-dimensional object with enhanced safety.

That is, in the forming method in the related art, it is difficult to enhance safety.

### SUMMARY

An advantage of some aspects of the invention is that it provides a technique which is capable of solving the above problems, which can be realized as the following embodiments or application examples.

### APPLICATION EXAMPLE 1

According to this application example of the invention, there is provided a forming method including: a process of drawing, using a thermosetting liquid which has a non-water-soluble property in at least a cured state, a sectional pattern of a three dimensional object which is a forming target on a water-soluble recording medium which has acceptability for the liquid; a process of heating, in a state where the plurality of recording mediums on which the sectional pattern is drawn is overlapped, the plurality of recording mediums, after the drawing process; and a process of dissolving at least an area outside the sectional pattern in each of the plurality of recording mediums using a liquid which includes water, after the heating process.

The forming method includes the drawing process, the heating process and the dissolving process.

In the drawing process, the sectional pattern of the three dimensional object which is the forming target is drawn on the recording medium using the liquid. The liquid has a thermosetting property. The liquid has the non-water-soluble property in at least the cured state. The recording medium has the acceptability for the liquid. The recording medium is water-soluble. In the heating process after the drawing process, the plurality of recording mediums is heated in a state where the plurality of recording mediums is overlapped. The sectional pattern is drawn on each of the plurality of recording mediums. The liquid is thermally cured by the heating process.

In the dissolving process after the heating process, at least the area outside the sectional pattern in each of the plurality of recording mediums is dissolved in a liquid which includes water. Through the dissolving process, at least the sectional pattern remains. Accordingly, it is possible to obtain a three dimensional object in which the plurality of sectional patterns is stacked.

In this forming method, the recording medium has acceptability for the liquid. That is, at least some of the liquid adhered to the recording medium penetrates into the recording medium. Thus, in a state where the plurality of recording mediums is overlapped, two adjacent sectional patterns are easily overlapped. As a result, even through the dissolving process, the sectional patterns are difficult to separate. Thus, according to this forming method, it is possible to form the three dimensional object while enhancing safety.

### APPLICATION EXAMPLE 2

In the above-described forming method, the heating process may include a process of heating the plurality of recording mediums while pressing the plurality of recording mediums.

In this application example, since the plurality of recording mediums is heated while being pressed in the heating process, two adjacent sectional patterns can be easily contacted. As a result, it is more difficult to separate the sectional patterns.

### APPLICATION EXAMPLE 3

In the above-described forming method, the heating process may include a process of pressing the plurality of recording mediums in a state where the plurality of recording mediums is pinched between a plurality of new recording mediums.

In this application example, since the plurality of recording mediums is pressed in a state of being pinched between the plurality of new recording mediums in the heating process, the liquid is difficult to adhere to a pressing tool used in the pressing process.

### APPLICATION EXAMPLE 4

In the above-described forming method, the recording medium may be porous.

In this application example, since the recording medium is porous, the recording medium can have the acceptability for the liquid.

### APPLICATION EXAMPLE 5

In the above-described forming method, the method may further include allowing resin to penetrate into the three dimensional object obtained after the dissolving process.

In this application example, since the resin is allowed to penetrate into the three dimensional object obtained after the dissolving process, it is possible to easily increase the strength of the three dimensional object.

### APPLICATION EXAMPLE 6

In the above-described forming method, the drawing process may include a process of drawing the sectional pattern on the recording medium using an ink jet device.

In this application example, since the sectional pattern is drawn on the recording medium using the ink jet device in the drawing process, it is possible to draw the sectional pattern using the liquid.

### APPLICATION EXAMPLE 7

In the above-described forming method, the drawing process may include a process of drawing the sectional pattern on the recording medium using a liquid which is colored.

In this application example, since the sectional pattern is drawn on the recording medium using a liquid which is colored in the drawing process, it is possible to obtain a colored three dimensional object.

### APPLICATION EXAMPLE 8

There is provided a three dimensional object formed by the above-described forming method.

The three dimensional object according to this application example is formed by the forming method including the drawing process, the heating process and the dissolving process.

In the drawing process, the sectional pattern of the three dimensional object which is the forming target is drawn on the recording medium using the liquid. The liquid has a thermosetting property. The liquid has the non-water-soluble property in at least the cured state. The recording medium has the acceptability for the liquid. The recording medium is water-soluble. In the heating process after the drawing process, the plurality of recording mediums is heated in a state where the plurality of recording mediums is overlapped. The sectional pattern is drawn on each of the plurality of recording mediums. The liquid is thermally cured by the heating process.

In the dissolving process after the heating process, at least the area outside the sectional pattern in each of the plurality of recording mediums is dissolved in the liquid which includes water. By the dissolving process, at least the sectional pattern remains. Accordingly, it is possible to obtain a three dimensional object in which the plurality of sectional patterns is stacked. In this forming method, the recording medium has the acceptability for the liquid. That is, at least some of the liquid adhered to the recording medium penetrates into the recording medium. Thus, in a state where the plurality of recording mediums is overlapped, two adjacent sectional patterns are easily overlapped. As a result, even through the dissolving process, the sectional patterns are difficult to separate. Thus, according to this forming method, it is possible to form the three dimensional object while enhancing safety.

Further, according to this three dimensional object, it is possible to enhance safety in the forming method.

### BRIEF DESCRIPTION OF THE DRAWINGS

The invention will be described with reference to the accompanying drawings, wherein like numbers reference like elements.

FIG. 1 is a diagram illustrating a schematic configuration of a forming system according to an embodiment of the invention.

FIGS. 2A and 2B are diagrams illustrating a schematic configuration of a printer according to the embodiment.

FIG. 3 is a bottom view of a discharge head according to the embodiment.

FIG. 4 is a sectional view taken along line B-B in FIG. 2B.

FIG. 5 is a block diagram illustrating a schematic configuration of a forming system according to the embodiment.

FIG. 6 is a diagram illustrating a flow of a forming method according to a first embodiment.

FIG. 7 is a perspective view illustrating a stacked body according to the first embodiment.

FIG. 8 is an exploded perspective view illustrating the stacked body according to the first embodiment.

FIG. 9 is a sectional view of a plurality of recording mediums taken along line D-D in FIG. 7.

FIG. 10 is a diagram illustrating a heating process according to a first embodiment.

FIG. 11 is a diagram illustrating a dissolving process according to the embodiment.

FIG. 12 is a perspective view illustrating an example of a three-dimensional object according to the embodiment.

FIG. 13 is a diagram illustrating a flow of a forming method according to a third embodiment.

FIG. 14 is a diagram illustrating a light irradiation process according to the third embodiment.

FIG. 15 is a diagram illustrating a light irradiation process according to the third embodiment.

FIG. 16 is a perspective view illustrating a stacked body according to the third embodiment.

### DESCRIPTION OF EXEMPLARY EMBODIMENTS

Preferred embodiments will be described with reference to the accompanying drawings. In the drawings, configurations and members may have different scales for the convenience of recognition.

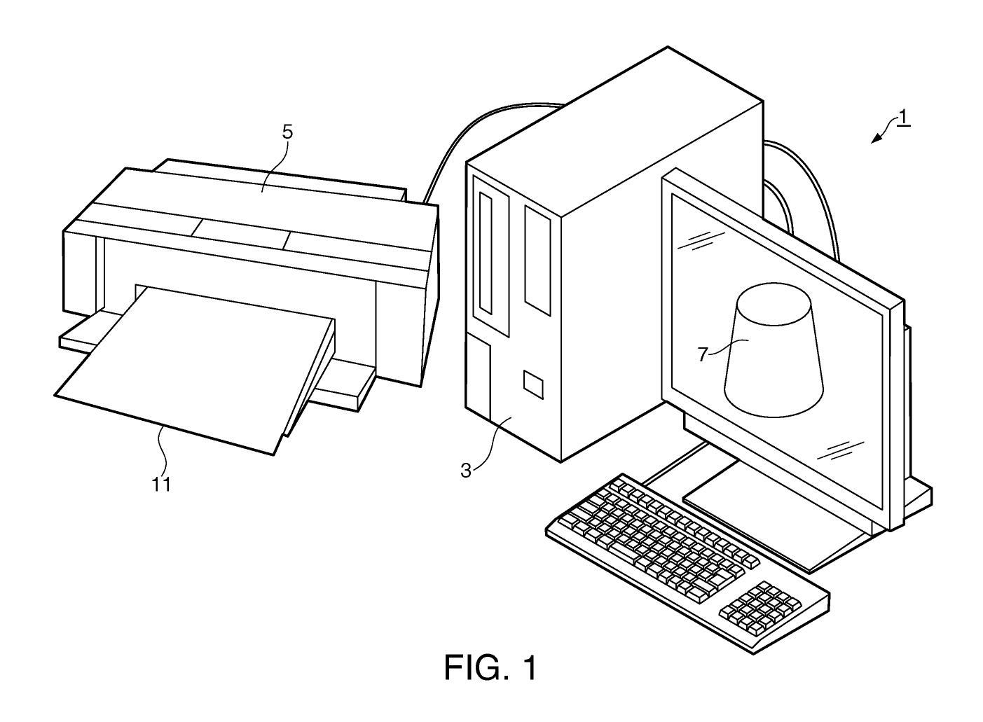

As shown in FIG. 1, a forming system 1 according to this embodiment includes a computer 3 and a printer 5.

The computer 3 performs an arithmetic process so that a plurality of sectional elements is extracted from shape data on a three-dimensional object 7 which is a forming target. Further, the computer 3 outputs data on the extracted sectional elements (hereinafter, referred to as sectional data) to the printer 5.

The printer 5 draws a sectional pattern corresponding to the sectional element using a liquid which will be described later on a recording medium 11, on the basis of the sectional data output from the computer 3.

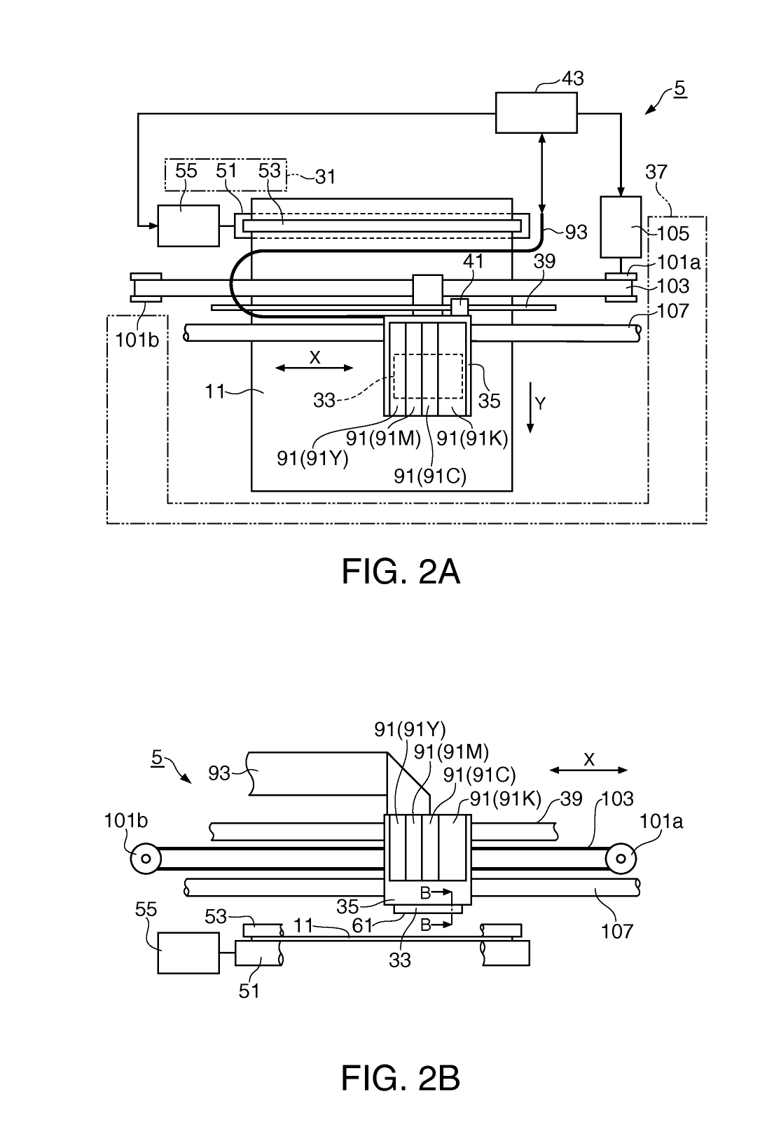

As shown in a plan view of FIG. 2A and a front view of FIG. 2B, the printer 5 includes a feeding device 31, a discharge head 33, a carriage 35, a carriage moving device 37, a linear scale 39, a linear encoder 41, and a control circuit 43. The printer 5 is a kind of ink jet device. The direction Y in the figure is the feeding direction of a recording medium 11 when seen from the planar view. Further, the direction X is a direction orthogonal to the direction Y when seen from the planar view.

The feeding device 31 includes a feeding roller 51, a pressing roller 53, and a feeding motor 55. The feeding roller 51 and the pressing roller 53 are able to rotate in a state where they are in contact with each other in their outer circumferences. The feeding motor 55 is controlled in operation by a control circuit 43, and generates power for rotating the feeding roller 51.

In the feeding device 31, the power is transmitted to the feeding roller 51 from the feeding motor 55, the recording medium 11 which is pinched between the feeding roller 51 and the pressing roller 53 is intermittently fed in the Y direction which is the feeding direction.

The discharge head 33 discharges a liquid from a plurality of nozzles, which will be described later as droplets, on the basis of a driving signal output from the control circuit 43.

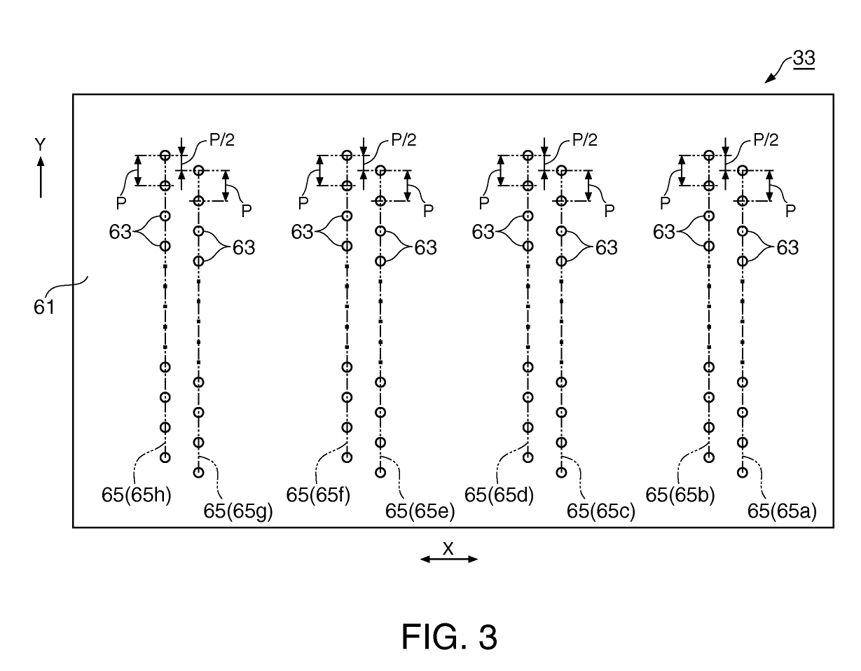

As shown in a bottom view of FIG. 3, the discharge head 33 includes a nozzle surface 61. A plurality of nozzles 63 is formed on the nozzle surface 61. In FIG. 3, for ease of understanding the nozzles 63, the nozzles 63 are magnified, and the number of nozzles 63 is reduced. In the discharge head 33, the plurality of nozzles 63 forms 8 nozzle arrays which are aligned along the Y direction. The 8 nozzle arrays 65 are arranged in a state of being spaced from each other in the X direction. In each nozzle array 65, the plurality of nozzles 63 is formed at a predetermined nozzle interval P along the Y direction.

Hereinafter, in a case where the 8 nozzle arrays 65 are respectively identified, representations of a nozzle array 65a, a nozzle array 65b, a nozzle array 65c, a nozzle array 65d, a nozzle array 65e, a nozzle array 65f, a nozzle array 65g and a nozzle array 65h are used, respectively.

In the discharge head 33, the nozzle array 65a and the nozzle array 65b are shifted by a distance of P/2 in the Y direction. The nozzle array 65c and the nozzle array 65d are also shifted by a distance of P/2 in the Y direction with each other. Similarly, the nozzle array 65e and the nozzle array 65f are shifted by a distance of P/2 in the Y direction with each other, and the nozzle array 65g and the nozzle array 65h are also shifted by a distance of P/2 in the Y direction with each other.

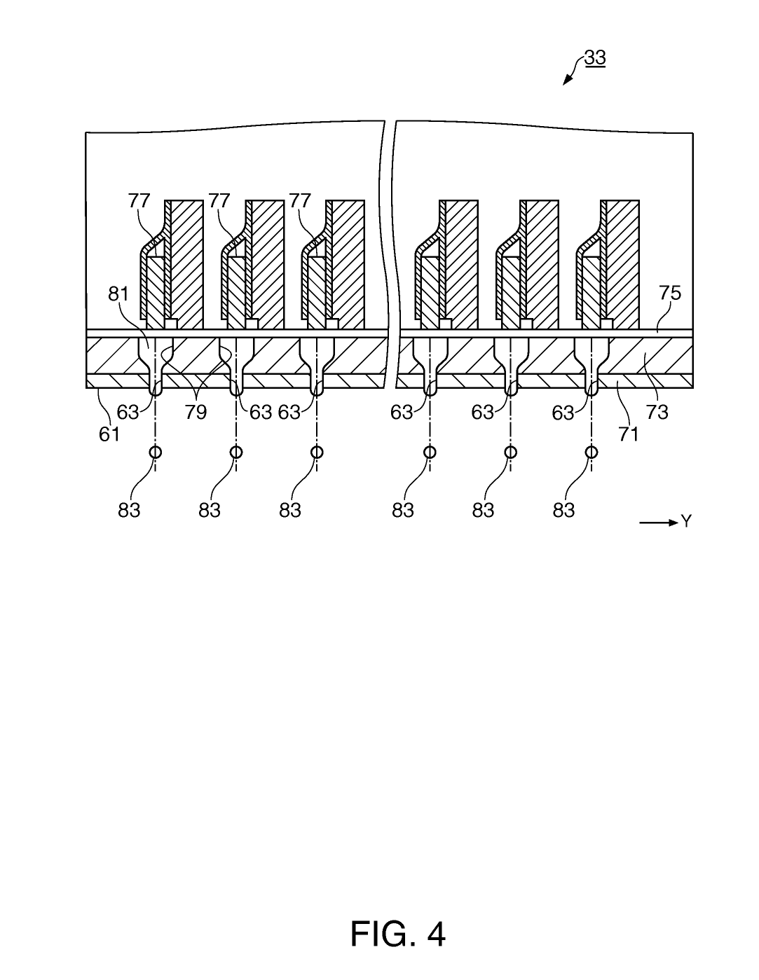

As shown in a sectional view of FIG. 4 taken along line B-B in FIG. 2B, the discharge head 33 includes a nozzle plate 71, a cavity plate 73, a vibration plate 75, and a plurality of piezoelectric elements 77.

The nozzle plate 71 includes the nozzle surface 61. The plurality of nozzles 63 is installed on the nozzle plate 71.

The cavity plate 73 is installed on a surface of the nozzle plate 71 opposite to the nozzle surface 61. A plurality of cavities 79 is formed on the cavity plate 73. Each cavity 79 is installed corresponding to each nozzle 63, and is communicated to each corresponding nozzle 63. A liquid 81 is supplied to each cavity 79 from an ink cartridge which will be described later.

The vibration plate 75 is installed on a surface of the cavity plate 73 opposite to the nozzle plate 71. As the vibration plate 75 vibrates (longitudinally vibrates) in a direction Z, the volume in the cavity 79 is enlarged or reduced.

The plurality of piezoelectric elements 77 is installed on a surface of the vibration plate 75 opposite to the cavity plate 73, respectively. Each piezoelectric element 77 is installed corresponding to each cavity 79, and faces each cavity 79 with the vibration plate 75 being interposed therebetween. Each piezoelectric element 77 extends on the basis of a driving signal. Thus, the vibration plate 75 reduces the volume in the cavity 79. At this time, pressure is applied to the liquid 81 in the cavity 79. As a result, the liquid 81 is discharged from the nozzle 63 as a droplet 83. The droplet 83 is discharged from the discharge head 33 using a kind of ink jet method. The ink jet method is a kind of coating method.

As shown in FIG. 2B, in the discharge head 33 having the above-described configuration, the nozzle surface 61 faces the recording medium 11.

As shown in FIGS. 2A and 2B, the carriage 35 supports the discharge head 33. Here, the discharge head 33 is supported by the carriage 35 in a state where the nozzle surface 61 faces the recording medium 11.

In this embodiment, the piezoelectric element 77 of a longitudinal vibration type is employed. However, a pressing means for applying pressure to the liquid 81 is not limited thereto. For example, a flexible piezoelectric element formed by stacking a lower electrode, a piezoelectric body layer and an upper electrode may be employed. Further, as the pressing means, for example, a so-called electrostatic actuator may be employed which generates static electricity between a vibration plate and electrodes, deforms the vibration plate by the electrostatic force, and discharges liquid droplets from the nozzle. Further, a configuration in which foam is generated in the nozzle using a heating element and pressure is applied to a liquid using the foam may be also employed.

Four ink cartridges 91 are mounted on the carriage 35. The respective ink cartridges 91 hold the above-described liquids 81 therein. In this embodiment, the liquids 81 include different color pigments for every ink cartridge 91. In this embodiment, the different colors for the respective ink cartridges 91 are yellow (Y), magenta (M), cyan (c) and black (K), respectively.

Hereinafter, in a case where four ink cartridges 91 are identified by color, representations of an ink cartridge 91Y, an ink cartridge 91M, an ink cartridge 91C and an ink cartridge 91K are used. Further, in a case where the liquids 81 are identified by color, representations of a liquid 81Y, a liquid 81M, a liquid 81C and a liquid 81K are used.

In this embodiment, since the liquids 81 of different four colors are employed, the three-dimensional object 7 can be formed being colored.

Here, the above-described 8 nozzle arrays 65 (FIG. 3) are distinguished according to the respective colors of the liquids 81. In this embodiment, the nozzles 63 which belong to the nozzle array 65a and the nozzle array 65b discharge the liquids 81K as the droplets 83. The nozzles 63 which belong to the nozzle array 65c and the nozzle array 65d discharge the liquids 81C as the droplets 83. The nozzles 63 which belong to the nozzle array 65e and the nozzle array 65f discharge the liquids 81M as the droplets 83. The nozzles 63 which belong to the nozzle array 65g and the nozzle array 65h discharge the liquids 81Y as the droplets 83.

As shown in FIG. 2B, the discharge head 33 is installed in the carriage 35 in a state where the nozzle surface 61 thereof is spaced from the recording medium 11. The driving signal output from the control circuit 43 (FIG. 2A) is transmitted to the discharge head 33 through a cable 93.

As shown in FIG. 2A, the carriage moving device 37 includes a pulley 101a, a pulley 101b, a timing belt 103, a carriage motor 105, and a guide shaft 107. The timing belt 103 extends between the pair of pulleys 101a and 101b along the X direction which is the main scanning direction, and a part thereof is fixed to the carriage 35.

The carriage motor 105 is controlled in operation by the control circuit 43, and generates power for rotating the pulley 101a. The guide shaft 107 extends along the X direction, and both ends thereof are supported by a casing (not shown). The guide shaft 107 guides the carriage 35 in the X direction.

In the carriage moving device 37, the power is transmitted to the carriage 35 from the carriage motor 105 through the pulley 101a and the timing belt 103. Thus, the carriage moving device 37 reciprocates the carriage 35 in the X direction.

Here, the linear scale 39 is installed to the printer 5 in the X direction. A plurality of scales is engraved on the linear scale 39 at a predetermined interval along the X direction. Further, the linear encoder 41 which optically detects the scales engraved on the linear scale 39 is arranged in the carriage 35.

In the printer 5, an X directional position of the carriage 35 is controlled on the basis of the detection of the scales by means of the linear encoder 41. The detection signal obtained when the linear encoder 41 detects the scales is transmitted to the control circuit 43 through the cable 93.

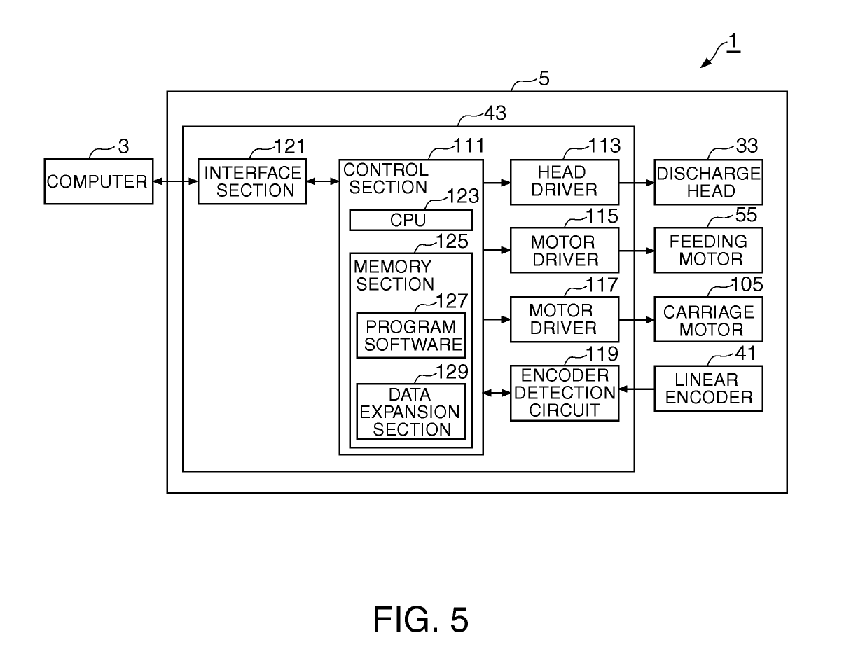

As shown in FIG. 5, the control circuit 43 includes a control section 111, a head driver 113, a motor driver 115, a motor driver 117, an encoder detection circuit 119, and an interface section 121.

For example, the control section 111 is configured as a microcomputer, and includes a CPU (central processing unit) 123 and a memory section 125.

The CPU 123 performs a variety of arithmetic processes as a processor.

The memory section 125 includes a RAM (random access memory), a ROM (read-only memory) or the like. In the memory section 125 are set an area which stores a program software 127 in which a control procedure of the operation in the printer 5 is written, a data development section 129 which is an area in which a variety of data is temporarily developed, or the like.

The head driver 113 outputs the driving signal to the discharge head 33 on the basis of a command from the CPU 123. The head driver 113 controls the driving of the discharge head 33 by outputting the driving signal to the discharge head 33.

The motor driver 115 controls the feeding motor 55 on the basis of a command from the CPU 123.

The motor driver 117 controls the carriage motor 105 on the basis of a command from the CPU 123.

The encoder detection circuit 119 detects a detection signal from the linear encoder 41, and then outputs the result to the control section 111.

The interface section 121 outputs sectional data received from the computer 3 to the control section 111, or outputs various information received from the control section 111 to the computer 3.

In the forming system 1 having the above-described configuration, the plurality of sectional elements is extracted from the shape data on the three-dimensional object 7 which is the forming target, using the computer 3. If the plurality of sectional elements is sequentially overlapped, the three-dimensional object 7 which is the forming target is formed. That is, each of the plurality of sectional elements is an element for forming the shape of the three-dimensional object 7 which is the forming target, respectively.

The computer 3 generates plural pieces of sectional data on the basis of the plurality of sectional elements which is extracted. At this time, one piece of sectional data is generated from one sectional element. The plural pieces of sectional data are output to the printer 5, respectively.

Further, in the printer 5, if the control section 111 obtains the sectional data, a drawing process starts by the CPU 123 . In the drawing process, the driving of the feeding motor 55 is controlled by the control section 111, and the feeding device 31 intermittently feeds the recording medium 11 in the Y direction with the recording medium 11 facing the discharge head 33. At this time, the control section 111 controls the driving of the carriage motor 105 to reciprocate the carriage 35 in the X direction, and controls the driving of the discharge head 33 to discharge the liquid droplets 83 at predetermined positions. Through this operation, dots by means of the liquid droplets 83 are formed on the recording medium 11. As a result, the sectional pattern based on the sectional data is drawn on the recording medium 11. In this embodiment, in the drawing of the sectional pattern, one sectional pattern is drawn on one recording medium 11.

In this embodiment, as the recording medium 11, a porous sheet is employed. As a material of the sheet, PVA (polyvinyl alcohol) is used. The PVA is water-soluble. Thus, the recording medium 11 according to the embodiment is water-soluble.

Further, since the recording medium 11 is porous, the recording medium 11 has acceptability to the liquid 81. The acceptability is the property of allowing easy penetration. That is, if the recording medium 11 has the acceptability for the liquid 81, this means that the liquid 81 easily penetrates into the recording medium 11.

For example, the porous sheet may be manufactured by utilizing a manufacturing method disclosed in JP-T-2007-519788. According to this manufacturing method, firstly, a mixture liquid obtained by mixing a surfactant and an organic solvent to a water solution of polyvinyl alcohol is adjusted. Then, emulsion is prepared from the mixed liquid, and then the emulsion is freeze-dried. Thus, a porous body of polyvinyl alcohol can be formed. By performing freeze-drying in a state where the emulsion expands in a sheet shape, or by cutting the porous body after the freeze-drying into a sheet shape, it is possible to manufacture a porous sheet.

Hereinafter, a first embodiment will be described.

In the first embodiment, a thermosetting liquid 81 is used as the liquid 81. The thermosetting property refers to a property where the curing of the liquid is facilitated by heating.

The thermosetting liquid 81 may include thermosetting resin, solvent or the like. The thermosetting resin may be obtained by adding a heat curing agent to resin. As the resin, for example, acrylic, epoxy resin or the like may be employed. As the heat curing agent, multiple-carboxylic acid anhydride, aliphatic multiple-carboxylic acid anhydride, aromatic multiple-carboxylic acid anhydride, ester group including acid anhydride, or the like are used, for example.

The liquid 81 which is employed in the first embodiment is non-water-soluble in its cured state.

Further, as the liquid 81 in the first embodiment, a configuration including solvent maybe employed, in addition to the above-described thermosetting resin. Thus, the viscosity of the liquid 81 can be reduced. Consequently, in the discharge head 33, the discharge performance of the liquid droplets 83 can be easily enhanced.

As the solvent, alcohol, phenol, aromatic ether, alcoxy-alcohol, glycol oligomer, alcoxy-alcohol ester, ketone, glycol ether, glycol ether ester, glycol oligomer ether, glycol oligomer ether ester, or the like are used, for example.

Here, the flow of a forming method according to the first embodiment will be described.

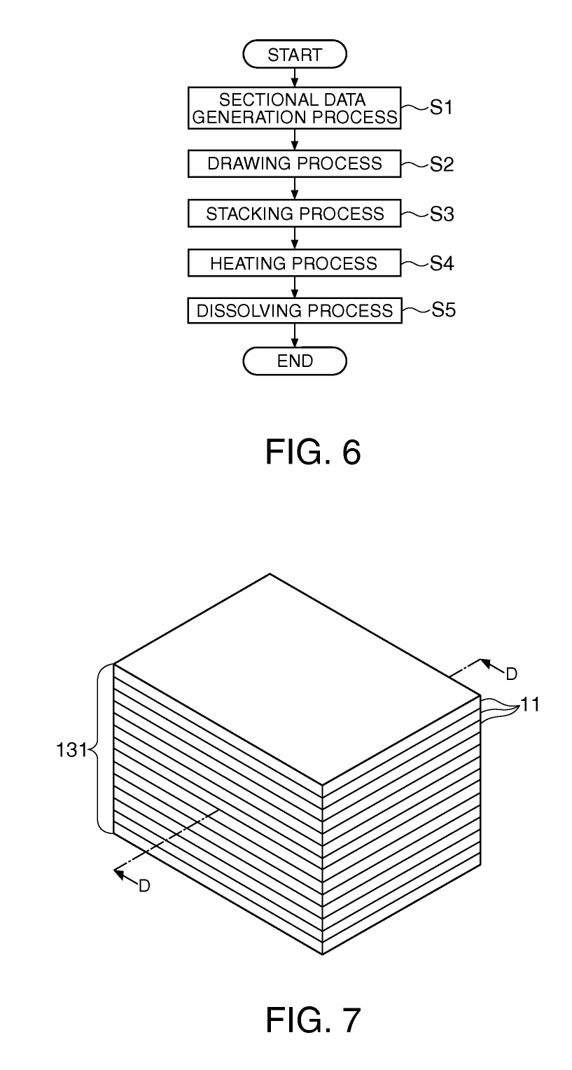

As shown in FIG. 6, the forming method according to the first embodiment includes a sectional data generation process S1, a drawing process S2, a stacking process S3, a heating process S4, and a dissolving process S5.

In the sectional data generation process S1, as described above, the plural pieces of sectional data are generated from the shape data on the three-dimensional object 7 which is the forming target. In the sectional data generation process S1, the sectional data is generated by the computer 3.

In the drawing process S2, as described above, the sectional pattern is drawn by the liquid 81 on the recording medium 11 on the basis of the sectional data. In the drawing process S2, the sectional pattern is drawn by the printer 5.

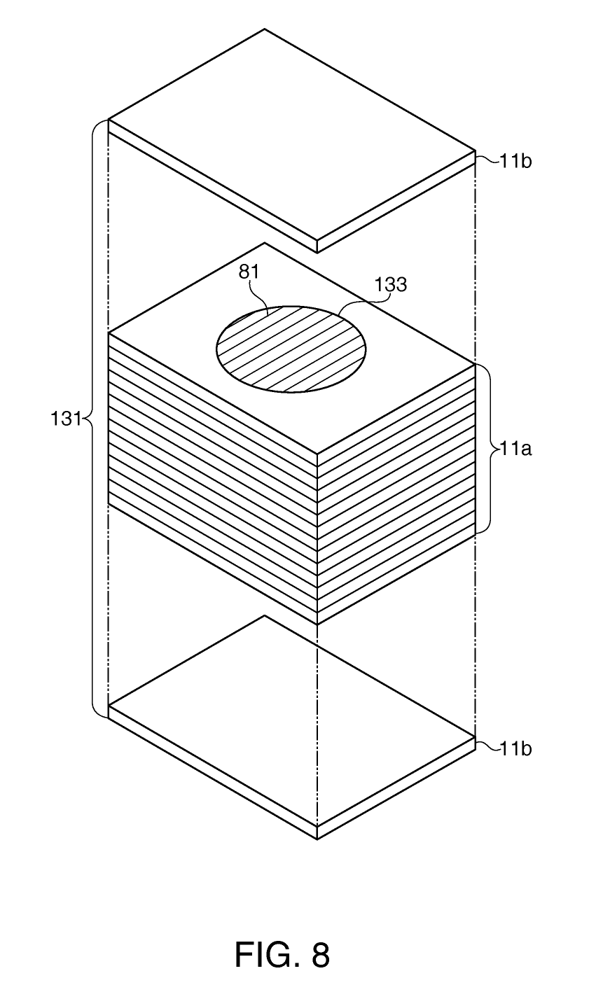

In the stacking process S3, the plurality of recording mediums 11 is stacked in the order of the sectional patterns. A stacked body 131 shown in FIG. 7 can be formed by the stacking process S3.

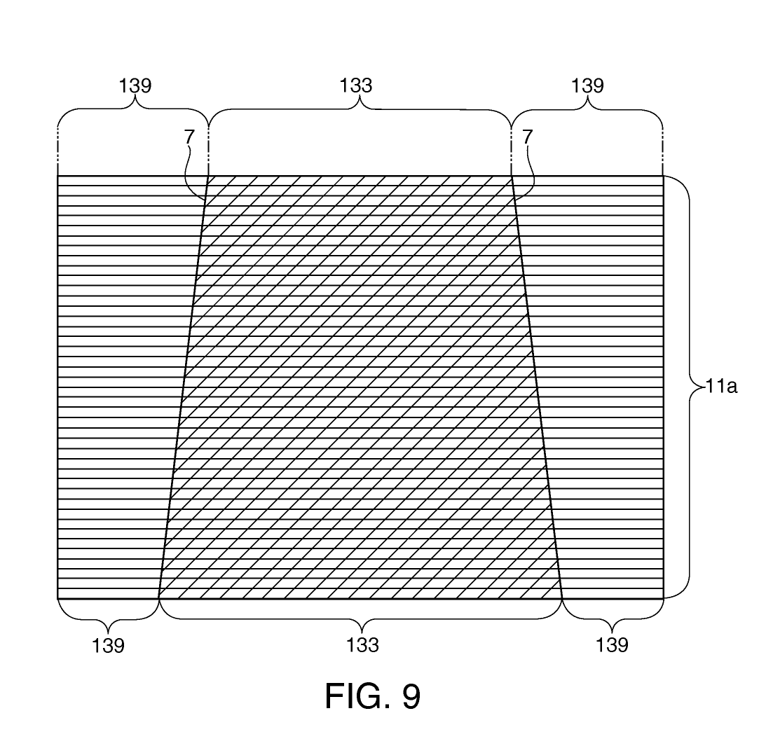

As shown in FIG. 8, the stacked body 131 includes a recording medium 11a on which a sectional pattern 133 is drawn by the liquid 81, and a new recording medium 11b on which the liquid 81 is not coated. The stacked body 131 includes a plurality of recording mediums 11b. In the stacked body 131, the plurality of recording mediums 11a is pinched by the plurality (here, two) of recording mediums 11b. In the stacked body 131, the plurality of sectional patterns 133 is stacked in the order of the sectional patterns 133, as shown in a sectional view of FIG. 9 of the plurality of recording mediums 11a taken along line D-D in FIG. 7, that is, according to the shape of the three-dimensional object 7. In FIG. 9, for easy understanding of the configuration, an area of the sectional pattern 133 is hatched.

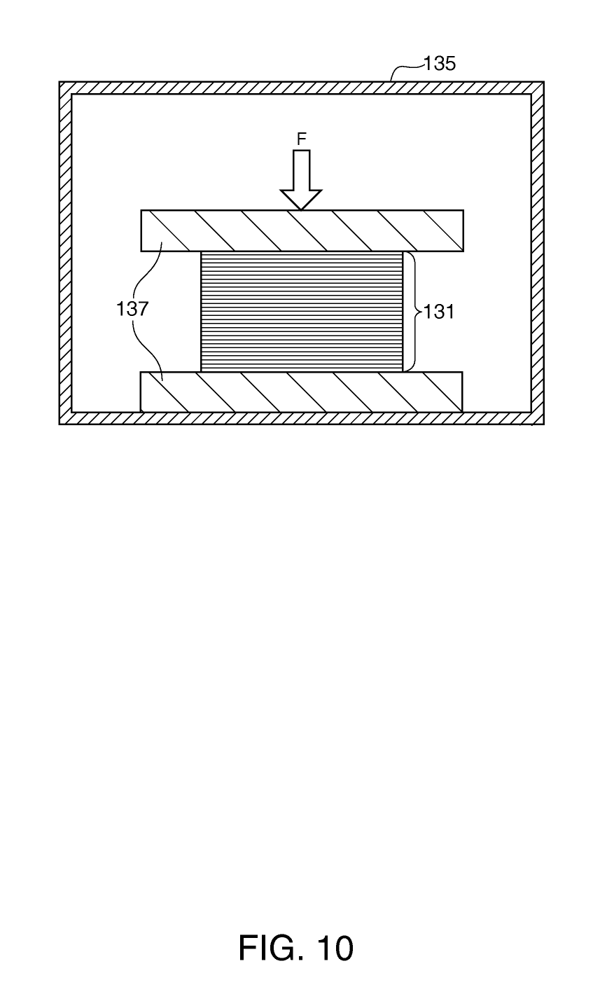

In the heating process S4, the stacked body 131 is heated. In this embodiment, a heating furnace 135 shown in FIG. 10 is used for heating of the stacked body 131. In the heating process S4, the stacked body 131 is heated in a state where the stacked body 131 is accommodated in the heating furnace 135.

At this time, the stacked body 131 is heated in a state where the stacked body 131 is pressed using a pinch member 137.

In the heating process S4, a pressing force F is applied to the stacked body 131 through the pinch member 137. Thus, in a state where the stacked body 131 is pressed, the stacked body 131 can be heated. At this time, as described above, in the stacked body 131, the plurality of recording mediums 11a (FIG. 8) is pinched by the plurality of recording mediums 11b. Thus, the pinch member 137 pinches the plurality of recording mediums 11a through the recording medium 11b. Accordingly, even though the pressing force F is applied to the stacked body 131, it is possible to restrain the liquid 81 from adhering to the pinch member 137 to a low level. As a result, defacement of the pinch member 137 can be suppressed to a lower level.

In the dissolving process S5, at least an area 139 outside the sectional pattern 133 in each of the plurality of recording mediums 11a shown in FIG. 9 is dissolved by a liquid which includes water.

As described above, the liquid 81 is non-water-soluble in the cured state. That is, the sectional pattern 133 which is cured through the heating process S4 is non-water-soluble. Further, the recording medium 11 is water-soluble. Thus, at least the area 139 outside the sectional pattern 133 in each of the plurality of recording mediums 11a can be dissolved by the liquid which includes water.

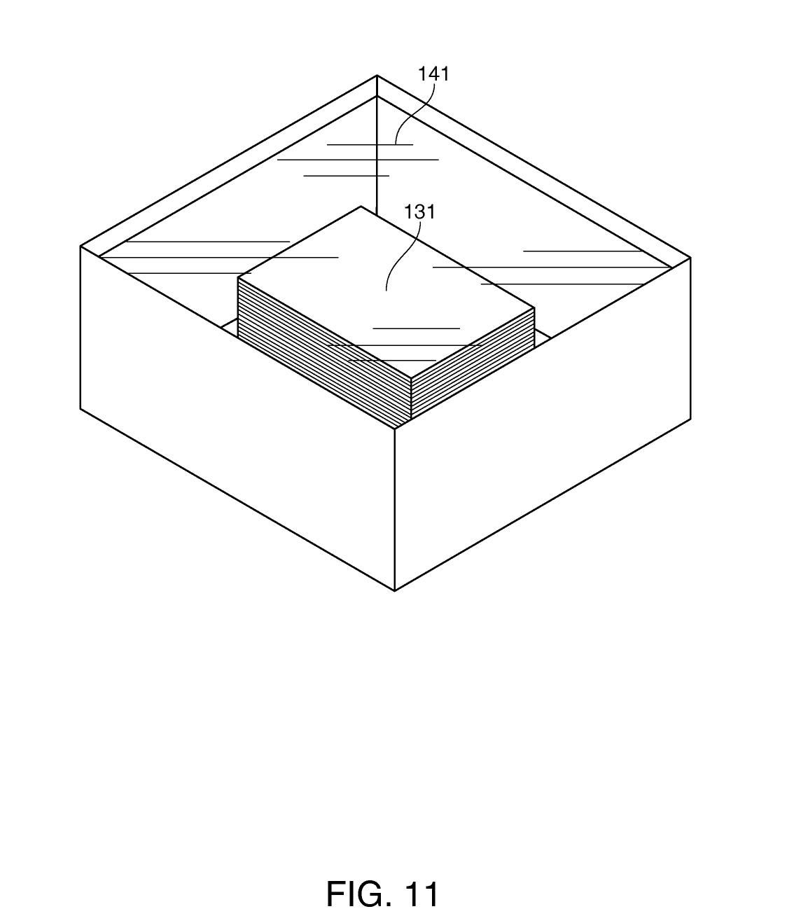

In this embodiment, as shown in FIG. 11, the area 139 is dissolved by dipping the stacked body 131 into the liquid 141 which includes water.

If the liquid 81 is not adhered to the recording medium 11b in the stacked body 131 in the stacking process S3 or the heating process S4, the recording medium 11b can be dissolved in the dissolving process S5. On the other hand, even though the liquid 81 is adhered to the recording medium 11b, the sectional pattern 133 is reflected on the adhesion shape of the liquid 81. Thus, the area 139 outside the sectional pattern 133 can be dissolved in the recording medium 11b.

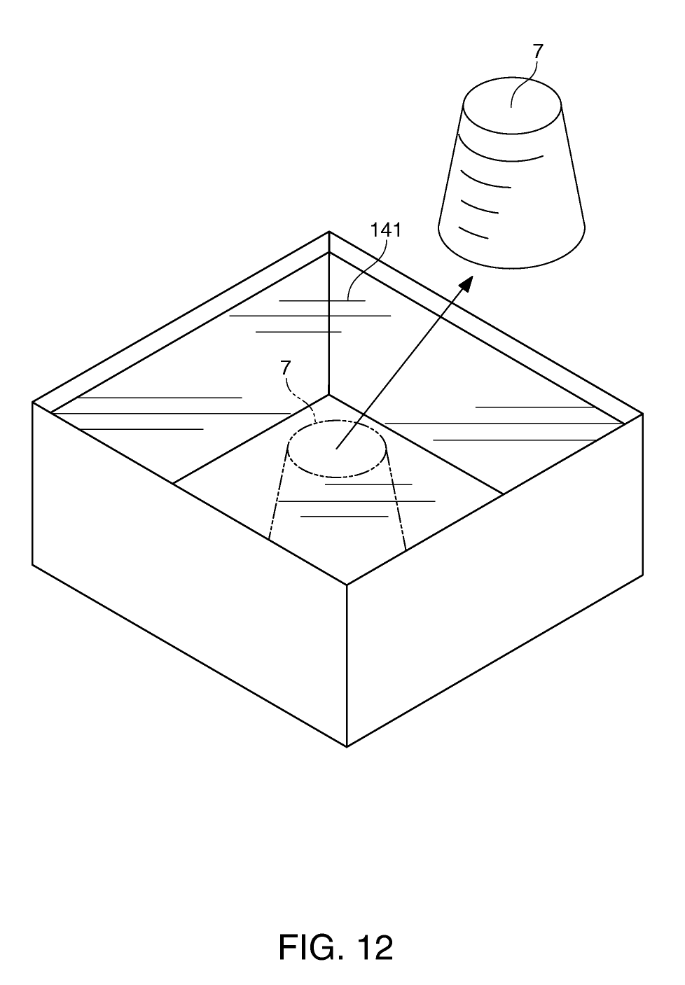

As a result, as the stacked body 131 is dipped to the liquid 141 which includes water, the three-dimensional object 7 can be formed as the three-dimensional object, as shown in FIG. 12.

Here, since the recording medium 11 is porous, the recording medium 11 has acceptability for the liquid 81 . Thus, in each recording medium 11a (FIG. 9), the sectional pattern 133 is cured in a state where part of the liquid 81 penetrates into the recording medium 11a. Further, between two adjacent recording mediums 11a, the sectional patterns 133 are easily in contact with each other. Thus, between the two adjacent recording mediums 11a, the sectional patterns 133 are easily adhered to each other. As a result, in the three-dimensional object 7 which is formed through the dissolving process S5, it is possible to easily restrain the adjacent sectional patterns 133 from being separated to a low level. That is, the three-dimensional object 7 which is formed through the dissolving process S5 has a holding force which holds the shape of the three-dimensional object 7.

In the first embodiment, since the stacked body 131 is heated in a state where the stacked body 131 is pressed in the heating process S4, the sectional patterns 133 can be easily in contact with each other between the two adjacent recording mediums 11a. As a result, in the three-dimensional object 7 which is formed through the dissolving process S5, it is possible to further easily restrain the adjacent sectional patterns 133 from being separated to a low level.

A second embodiment will be described.

In the second embodiment, a configuration of the liquid 81 and a configuration of the recording medium 11 are different from those of the first embodiment. The second embodiment is the same as in the first embodiment, except that the configuration of the liquid 81 and the configuration of the recording medium 11 are different. Accordingly, hereinafter, the same reference numerals as in the first embodiment are given to the same configuration or processes as in the first embodiment, and thus, detailed description thereof will be omitted.

In the second embodiment, the liquid 81 may include a liquid obtained by removing the heat curing agent from the liquid 81 in the first embodiment. The liquid 81 in the second embodiment has the same configuration as the liquid 81 according to the first embodiment, except that the heat curing agent is removed. Further, in the second embodiment, the recording medium 11 may include a recording medium obtained by adding the heat curing agent to the recording medium 11 in the first embodiment. The recording medium 11 in the second embodiment has the same configuration as the recording medium 11 in the first embodiment, except that the heat curing agent is added thereto.

A manufacturing method according to the second embodiment includes the same processes as in the manufacturing method (FIG. 6) according to the first embodiment.

In the second embodiment, in the drawing process S2, if the sectional pattern 133 is drawn on the recording medium 11, the liquid 81 and the heat curing agent are mixed with each other. Thus, the liquid 81 in the sectional pattern 133 has a thermosetting property. Thus, in the same forming method (FIG. 6) as in the first embodiment, the three-dimensional object 7 can be formed. Further, in the second embodiment, in the stacking process S3, the stacked body 131 in which the plurality of recording mediums 11a is pinched between the plurality of recording mediums 11b is formed.

In the second embodiment, the same effect as in the first embodiment is also achieved.

In the first and second embodiments, the recording medium 11b corresponds to a new recording medium.

In order to add the heat curing agent to the recording medium 11, a variety of types such as a type allowing the heat curing agent to penetrate into the recording medium 11, or a type adding a microcapsule or the like which contains the heat curing agent to the recording medium 11 may be employed.

A third embodiment will be described.

In the third embodiment, a configuration of the liquid 81 is different from that in the first embodiment. In the third embodiment, as the liquid 81, a thermosetting liquid 81 whose curing is facilitated by irradiation of ultraviolet light, which is a kind of light, may be employed.

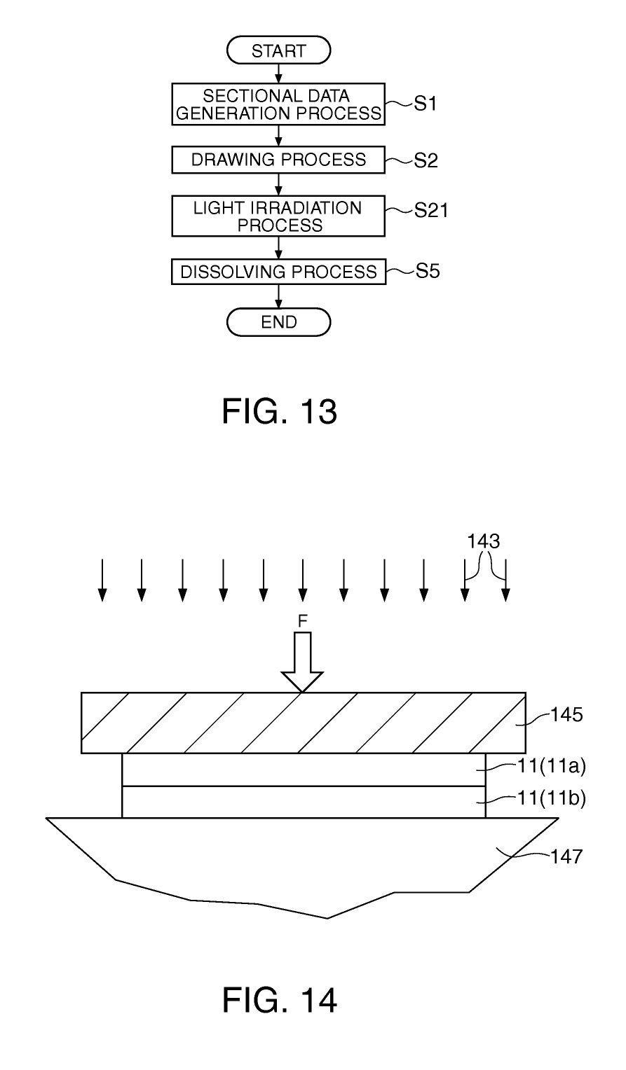

Further, as shown in FIG. 13, the forming method according to the third embodiment has a light irradiation process S21. In the forming method according to the third embodiment, the stacking process S3 and the heating process S4 are removed from the forming method (FIG. 6) according to the first embodiment.

The third embodiment is the same as in the first embodiment, except the above-described difference. Accordingly, hereinafter, the same reference numerals are given to the same configuration or processes as in the first embodiment, and thus, detailed description thereof will be omitted.

The liquid 81 having a light curable property may include a liquid including a light curable resin or the like. The light curable resin may include a resin obtained by adding a light curing agent to resin. As the resin, for example, acrylic or epoxy resin may be employed. As the light curing agent, for example, a photo-polymerization initiator of a radical polymer type, or a photo-polymerization initiator of a cation polymer type may be employed.

As the photo-polymerization initiator of the radical polymer type, isobutyl benzoin ether, isopropyl benzoin ether, benzoin ethyl ether, benzoin methyl ether, benzyl, hydroxycyclohexyl phenyl ketone, di-ethoxyacetophenone, chlorothioxanthone, isopropyl thioxanthone, or the like are used, for example.

Further, as the photo-polymerization initiator of the cation polymer type, an aryl sulfonium salt derivative, an aryl iodinium salt derivate, a diazonium salt derivate, a tri-azine initiator or the like are used, for example.

Further, the liquid 81 used in the third embodiment is non-water-soluble in a cured state.

A flow of the forming method according to the third embodiment will be described.

As shown in FIG. 13, the forming method according to the third embodiment includes a sectional data generation process S1, a drawing process S2, a light irradiation process S21 and a dissolving process S5. The light irradiation process S21 is disposed between the drawing process S2 and the dissolving process S5.

The sectional data generation process S1, the drawing process S2, and the dissolving process S5 are the same as in the first embodiment, respectively. Accordingly, hereinafter, the flow of the light irradiation process S21 will be described.

As shown in FIG. 14, in the light irradiation process S21, firstly, the recording medium 11a on which a first sectional pattern 133 is drawn is overlapped with the recording medium 11b, and then, at least the sectional pattern 133 of the recording medium 11a is irradiated with an ultraviolet light 143. At this time, a substrate 145 is overlapped with the recording medium 11a.

The substrate 145 has light permeability which is a property of transmitting at least part of the ultraviolet light 143. As the substrate 145, quartz, glass or the like may be employed, for example. The recording medium 11a is irradiated with the ultraviolet light 143 through the substrate 145. Further, at this time, a pressing force F is applied to the recording medium 11a through the substrate 145. Thus, the recording medium 11a can be irradiated with the ultraviolet light 143 in a state where the recording medium 11a is pressed.

Here, the recording medium 11b is interposed between a mounting base 147 such as a table and the recording medium 11a. Thus, even though the pressing force F is applied to the recording medium 11a, it is possible to restrain the liquid 81 from being adhered to the mounting base 147 to a low level. As a result, defacement of the mounting base 147 can be suppressed to a low level.

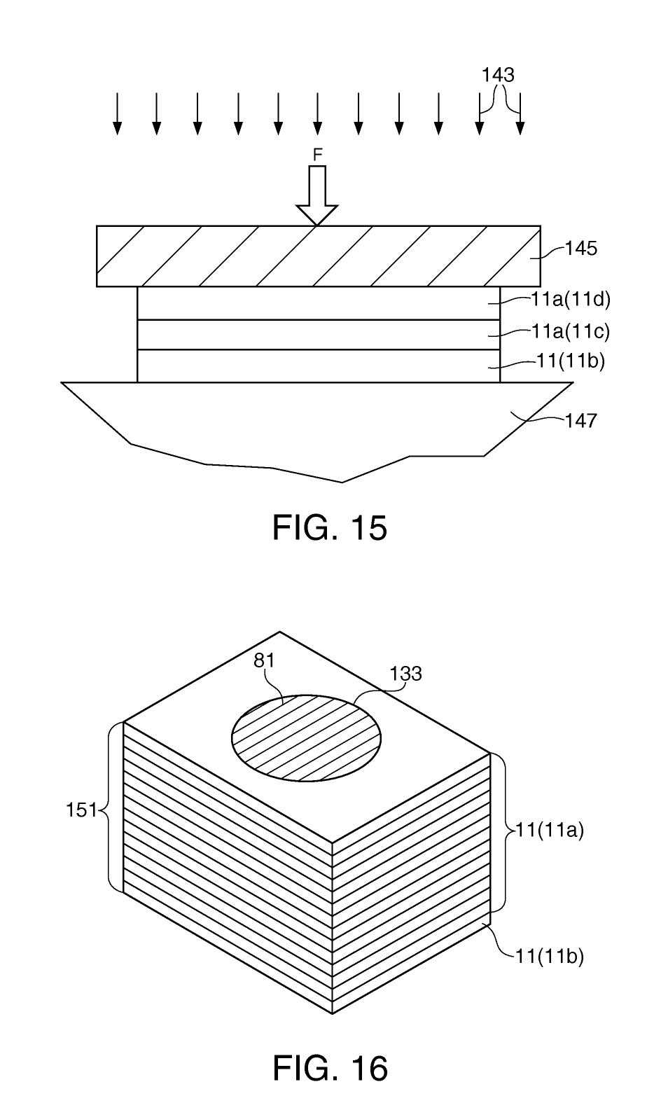

Next, as shown in FIG. 15, in the light irradiation process S21, a different recording medium 11d which is the recording medium 11a before being irradiated with the ultraviolet light 143 is overlapped with a recording medium 11c which is the recording medium 11a irradiated with the ultraviolet light 143 in advance (hereinafter, referred to as a medium mounting process).

Then, the substrate 145 is overlapped with the different recording medium 11d (hereinafter, referred to as a substrate mounting process). Subsequently, at least the sectional pattern 133 of the recording medium 11d is irradiated with the ultraviolet light 143 through the substrate 145 (hereinafter, referred to as an irradiation process) . At this time, the pressing force F is applied to the recording medium 11d through the substrate 145. Thus, in a state where the recording medium 11d is pressed, the recording medium 11d can be irradiated with the ultraviolet light 143. As a result, it is possible to easily bring the sectional pattern 133 of the recording medium 11d into contact with the sectional pattern of the recording medium 11c.

Hereinafter, the medium mounting process, the substrate mounting process and the irradiation process are sequentially repeated until the final sectional pattern 133 is completed for each recording medium 11a (until the recording medium 11d is exhausted). Thus, a stacked body 151 shown in FIG. 16 can be formed.

Further, in the third embodiment, the same effect as in the first and the second embodiments can be achieved.

A fourth embodiment will be described.

In the fourth embodiment, a configuration of the liquid 81 and a configuration of the recording medium 11 are different from those in the third embodiment. The fourth embodiment is the same as in the third embodiment, except that the configuration of the liquid 81 and the configuration of the recording medium 11 are different. Accordingly, hereinafter, the same reference numerals are given to the same configuration or processes as in the third embodiment, and thus, detailed description thereof will be omitted.

In the fourth embodiment, the liquid 81 may include a liquid obtained by removing the light curing agent from the liquid 81 according to the third embodiment. The liquid 81 in the fourth embodiment has the same configuration as the liquid 81 in the third embodiment, except that the light curing agent is removed. Further, in the fourth embodiment, the recording medium 11 may include a recording medium obtained by adding a light curing agent to the recording medium 11 in the first embodiment or the third embodiment. The recording medium 11 in the fourth embodiment has the same configuration as the recording medium 11 in the first embodiment or the third embodiment, except that the light curing agent is added thereto.

In the fourth embodiment, in the drawing process S2, if the sectional pattern 133 is drawn on the recording medium 11, the liquid 81 and the light curing agent are mixed with each other. Thus, the liquid 81 in the sectional pattern 133 has a light curable property. Thus, the three-dimensional object 7 can be formed in the same forming method as in the third embodiment (FIG. 13).

Further, in the fourth embodiment, the same effect as in the third embodiment is obtained.

In the third and fourth embodiments, the recording medium 11d corresponds to the different recording medium.

In order to add the light curing agent to the recording medium 11, a variety of types such as a type allowing the light curing agent to penetrate into the recording medium 11, a type adding the microcapsule or the like which contains the light curing agent to the recording medium 11, or the like, may be employed.

In each of the first to fourth embodiments, in the dissolving process S5, the dissolving can be facilitated by heating the liquid 141 or adjusting PH of the liquid 141.

Further, in each of the first to fourth embodiments, a process of allowing resin to penetrate into the formed three-dimensional object 7 may be added thereto. Thus, it is possible to increase the strength of the three-dimensional object 7 or to give glaze to the three-dimensional object 7.

In addition, in each of the first to fourth embodiments, PVA is used as the material of the recording medium 11, but the material of the recording medium 11 is not limited thereto, and a variety of water-soluble materials may be used.

Further, in each of the first to fourth embodiments, the porous recording medium 11 is used, but the type of the recording medium 11 is not limited thereto. As the type of the recording medium 11, a variety of types such as a recording medium having a weaved or overlapped fabric, a recording medium formed with net-like gaps or holes, or the like may be employed, for example.

Further, in the first to fourth embodiments, the liquids 81 include pigments, respectively. However, the configuration of the liquid 81 is not limited thereto, and a configuration in which the pigment is removed may be employed.

In addition, the colors of the liquids 81 are not limited to yellow, magenta, cyan and black. That is, an arbitrary type such as a type of 5 colors further including white, a type of 6 colors further including light cyan and light magenta, or the like may be employed. Further, as a liquid 81, the liquid 81 having light permeability may be also employed.

The entire disclosure of Japanese Patent Application No. 2010-004648, filed Jan. 13, 2010 is expressly incorporated by reference herein.

What is claimed is:

1. A forming method comprising:
drawing, using a thermosetting liquid which has a non-water-soluble property in at least a cured state, a sectional pattern of a three dimensional object which is a forming target on a water-soluble recording medium which has acceptability for the liquid;
heating, in a state where the plurality of recording mediums on which the sectional pattern is drawn is overlapped, the plurality of recording mediums, after the drawing; and
dissolving at least an area outside the sectional pattern in each of the plurality of recording mediums using a liquid which includes water, after the heating.

2. The method according to claim 1,
wherein the heating includes heating the plurality of recording mediums while pressing the plurality of recording mediums.

3. The method according to claim 2,
wherein the heating includes pressing the plurality of recording mediums in a state where the plurality of recording mediums is pinched between a plurality of new recording mediums.

4. The method according to claim 1,
wherein the recording medium is porous.

5. The method according to claim 4,
further comprising allowing resin to penetrate into the three dimensional object obtained after the dissolving.

6. The method according to claim 1,
wherein the drawing includes drawing the sectional pattern on the recording medium using an ink jet device.

7. The method according to claim 1,
wherein the drawing includes drawing the sectional pattern on the recording medium using a liquid which is colored.

8. A three dimensional object formed by the method according to claim 1.

9. A three dimensional object formed by the method according to claim 2.

10. A three dimensional object formed by the method according to claim 3.

11. A three dimensional object formed by the method according to claim 4.

12. A three dimensional object formed by the method according to claim 5.

13. A three dimensional object formed by the method according to claim 6.

14. A three dimensional object formed by the method according to claim 7.
